(19) United States
(12) Patent Application Publication
(10) Pub. No.: US 2020/0346297 A1
(43) Pub. Date: Nov. 5, 2020

(54) WIRE FORMING UNIT AND WELDING TORCH WITH WIRE FORMING UNIT

(71) Applicant: FRONIUS INTERNATIONAL GmbH, Pettenbach (AT)

(72) Inventors: Andreas LEONHARTSBERGER, Pettenbach (AT); Wolfgang HABERLER, Pettenbach (AT); Daniel PLATZER, Pettenbach (AT); Klaus OBERNDORFER, Pettenbach (AT)

(73) Assignee: FRONIUS INTERNATIONAL GmbH, Pettenbach (AT)

(21) Appl. No.: 16/961,373

(22) PCT Filed: Jan. 9, 2019
(86) PCT No.: PCT/EP2019/050414

§ 371 Date: Jul. 10, 2020

(30) Foreign Application Priority Data
Jan. 11, 2018 (EP) 18151210.4

(51) Int. Cl. B23K 9/133; B23K 9/12

(52) U.S. Cl. CPC B23K 9/133; B23K 9/122

(57) ABSTRACT

In order to achieve a reliable constant contact in a welding torch with a contact sleeve with a wire forming unit and to reduce the frictional forces for the wire forming process three ball bearing-mounted rollers (4a, 4b, 4c) are arranged one behind the other in the longitudinal direction (x) of the welding torch (10) in the wire forming unit (1), whereas the central roller (4b), when viewed in the longitudinal direction (x), is offset in the wire forming unit (1) relative to the two outer rollers (4a, 4c), when viewed in the longitudinal direction (x), by a transverse offset (V) in a transverse direction (y) transverse to the longitudinal direction (x) in order to form a zig-zag-shaped path for the welding wire (3) through the wire forming unit (1), wherein the axial distance (A) between the two outer rollers (4a, 4c) when viewed in the longitudinal direction (x) is maximally 35 mm, preferably maximally 30 mm, more preferably maximally 20 mm.

The present invention relates to a wire forming unit for forming a welding wire for a welding torch having a contact sleeve and to a welding torch having a contact sleeve having such a wire forming unit.

Welding processes using a consumable electrode are sufficiently well known, It is also known in connection to use the welding wire itself as an electrode by feeding the welding wire to a welding torch using a welding wire feed unit, in which welding torch a contact sleeve is arranged that is raised to an electrical potential. The welding wire contacts the contact sleeve while being fed through the welding torch, which allows an electrical welding current to flow through the welding wire via the contact sleeve if the electrical welding circuit is closed via the welding arc that forms between the welding wire and the workpiece to be welded (which is usually at ground potential). Examples of such welding processes are metal inert gas (MIG) welding and metal active gas (MAG) welding, in which a protective gas is additionally supplied to the welding point.

An important factor for the quality of the weld in such welding processes is the contact between the contact sleeve and the welding wire. On the one hand, a sufficiently high contact force is required to achieve reliable electrical contacting. In addition, the contact point between the welding wire and the contact sleeve should remain the same as far as possible. If the contact force and/or the contact point varies, there may be uncontrolled fluctuation in the contact resistance, which in turn causes uncontrolled fluctuation in the flowing welding current and the welding arc. This worsens the quality of the weld.

For the contacting, the feeding of the welding wire into the contact sleeve is of primary importance. The welding wire is usually wound on a welding wire reel or in a welding wire drum and is fed to the welding torch via a welding wire feed unit. Due to the winding of the welding wire, the welding wire has a certain bend, i.e. a certain bending condition. Furthermore, the bendcan also be changed by the hose pack through which the welding wire is fed to the welding torch because the hose pack may be in any position. Due to the uncontrolled bend and position (orientation) of the welding wire, the contact point and the contact force of the welding wire in the welding torch cannot be controlled, which can result in the problems mentioned above. Last but not least, the relative position of the welding torch to the hose pack may change the orientation of the welding wire in the contact sleeve. This is particularly the case if the welding torch is arranged on a welding robot and the welding robot changes the spatial position of the welding torch for welding.

Therefore, wire forming units are already used in the prior art to change the bend of the welding wire. This requires plastic deformation of the welding wire to give the welding wire a different bend.

DE 1 923 995 A1 describes, for example, a device for straightening the welding wire upstream of the welding wire feed unit. This device consists of three rollers, two external rollers being aligned on the longitudinal axis of the welding wire and a third roller arranged therebetween being displaced transversely to the longitudinal axis such that a curvature is impressed on the welding wire as it passes through the device. In addition, the device is rotated about the longitudinal direction. The curvature introduced by the rollers and the rotation of the rollers is intended to compensate for the curvature of the welding wire on the welding wire reel and to straighten the welding wire. The problem is that the welding wire in the hose pack, which can be very long, may again experience uncontrolled bend, which means that the contact in a contact sleeve cannot be improved reliably. The wire bend adapts to the smallest amount of bending work required in the hose pack and is therefore not related to the welding torch. This means that despite a lower wire bend being achieved, it is neither possible to predict how the welding wire will leave the welding torch, which makes the position of the weld indefinite, nor can the contact point of the welding wire in the contact sleeve be predicted, which makes the contacting indefinite.

A similar device for wire forming is shown in U.S. Pat. No. 4,074,105 A, which in this case is arranged closer to the welding torch. The rotation of the wire forming unit specifically introduces a bend into the welding wire, which causes the welding wire emerging from the welding torch to rotate in a spiral. The welding wire also executes the same rotation in the contact sleeve, whereby the contact point in the contact sleeve is not constant and the above-mentioned problems with the contacting in the contact sleeve may occur again.

In addition, welding torches are also known in which a guide device is arranged in the welding torch to guide and align the welding wire. An example of this is DE 298 80 112 U1, which shows a welding torch in which a transition piece is arranged, in which the welding wire fed with a certain bend is straightened. The extent of straightening is influenced via the length of the transition piece and may cause considerable sliding friction forces. By straightening the welding wire upstream of the contact sleeve, it is easier to insert the welding wire, but reliable contact cannot be achieved therewith because the contact point in the contact sleeve is thereby indefinite. High sliding friction forces require higher wire feed forces, and the welding wire can only be fed with a limited wire feed frequency.

US 2009/0152255 A1 shows a welding torch having a contact sleeve with which reliable, constant contacting in the contact sleeve can be achieved despite a changing bend of the fed welding wire and despite possible tilting or rotation of the welding wire in the welding torch (due to a movement of the welding torch). This is achieved by providing three bending points for the welding wire in the welding torch. A bending point is a point where the welding wire lies against a part in the welding torch. The bending points thus act as supports for the welding wire past which the welding wire is moved. The bending points are offset from each other transversely to the longitudinal direction such that the welding wire bends when it is passed through the welding torch. It is essential here that the third bending point is formed in the contact sleeve such that the contact force is to be more independent of the bend of the fed welding wire. Because the third bending point is formed in the contact sleeve, the contact force may be increased and the contacting improved, but this results in relatively high frictional forces between the welding wire and the contact sleeve, which in turn increases the feed force required for the welding wire to be fed through the welding torch. Welding processes with highly dynamic wire feeding can thus hardly be carried out. Apart from that, this wire forming allows a contact point having a high contact force to be achieved in the contact sleeve, but the exact position of the contact point can only be controlled with difficulty, if at all, because the direction of curvature of the welding wire remains indefinite.

EP 3 088 117 A1 shows a device for straightening the welding wire upstream of the welding torch. The device comprises two roller groups, each having five rollers arranged offset relative to one another, between which the welding wire is passed in a zigzag shape. The axes of rotation of the rollers of the two roller groups are also offset by 90° relative to one another. There are three deflections of the welding wire in each of the roller groups to straighten the welding wire. This device is unsuitable for reliably contacting a contact sleeve with the welding wire in the welding torch because the welding wire requires a defined curvature to determine the position of the contact point and the contact force in the contact sleeve. In addition, the device for straightening is arranged upstream of the welding torch on a welding robot such that the welding wire may again be given uncontrolled bend between the device and the welding torch by the movement of the robot arm. For this reason too, a reliable contact point or a reliable contact force in a contact sleeve of a welding torch would not be possible.

It is therefore an object of the present invention to improve a welding torch having a contact sleeve in such a way that, on the one hand, reliable, constant contacting is achieved and, on the other hand, the frictional forces for wire forming are reduced.

This object is achieved in that three bail bearing-mounted rollers are arranged one behind the other in the longitudinal direction of the welding torch in the wire forming unit, wherein the central roller, when viewed in the longitudinal direction, being offset in the wire forming unit relative to the two outer rollers, when viewed in the longitudinal direction, by a transverse offset in a transverse direction transverse to the longitudinal direction in order to form a zig-zag-shaped path for the welding wire through the wire forming unit, whereas the longitudinal distance between the two outer rollers when viewed in the longitudinal direction being maximally 35 mm, preferably maximally 30 mm, more preferably maximally 20 mm. The ball bearing mounting minimizes the frictional forces in the wire forming unit as much as possible. On the one hand, the specified axial distance allows the required bend to be achieved by a small transverse offset, which reduces the size. At the same time, this ensures that the necessary deflections on the two outer rollers for the further transport of the welding wire do not become so great that the bend on the central roller is eliminated in part or in full by undesired further plastic deformation.

For an optimal result of the bend, the transverse offset is set depending on the welding wire, preferably depending on the welding wire diameter and/or welding wire material.

If at least one roller is mounted on two ball bearings arranged next to one another, the bearing forces may be reduced, which in turn makes it possible to use smaller ball bearings. The size of the wire forming unit can thus be further reduced.

In a welding torch having a contact sleeve, the wire forming unit is arranged in a defined and fixed installation position relative to the welding torch. In this way, a defined orientation of the formed welding wire in the welding torch may be ensured, whereby the contacting of the welding wire in a contact sleeve may be improved. In addition, a Tool Center Point (TCP) is set in a defined way so that a constant welding quality is guaranteed. The result is a stable arc that burns between the welding wire end and TCP on the workpiece due to the consistently defined position of the welding wire end and TCP during a welding process.

The welding torch may comprise a torch base, and the wire forming unit may be arranged in the torch base. If the torch base comprises a wire feed unit or is designed as a wire feed unit, the wire forming unit may advantageously also be arranged in the wire feed unit.

The welding torch may comprise a torch neck, at the free end of which a torch head having the contact sleeve is arranged and the other end of which is connected via a connecting piece to a torch base or a hose pack, and the wire forming unit may be arranged in the torch neck or in the connecting piece.

The welding torch may be connected to a hose pack via a hose pack coupling, and the wire forming unit may be arranged in the hose pack coupling.

A robot connecting piece to a welding robot may be arranged on the welding torch, and the wire forming unit may be arranged in said robot connecting piece.

Because of the small size, the wire forming unit can thus be arranged in a welding torch in a variety of ways, which enables very flexible use.

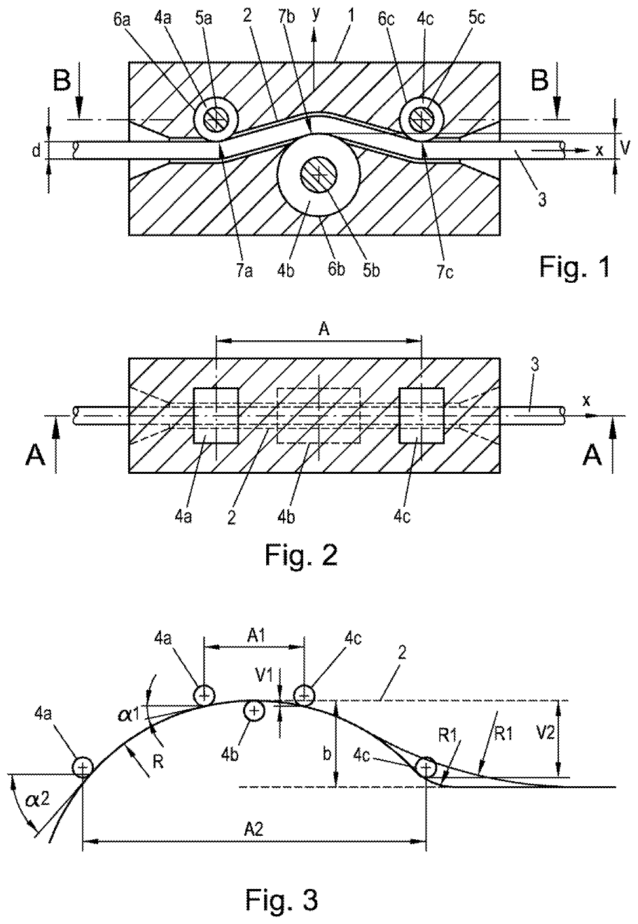

In the following, the present invention is described in greater detail with reference to FIGS. 1 to 8, which, by way of example, show schematic and non-limiting advantageous embodiments of the invention. In the figures:

FIG. 1 and 2 each show a section through an advantageous embodiment of a wire forming unit according to the invention.

FIG. 3 shows the generation of the desired bend by the axial distance and transverse offset of the rollers of the wire forming unit,

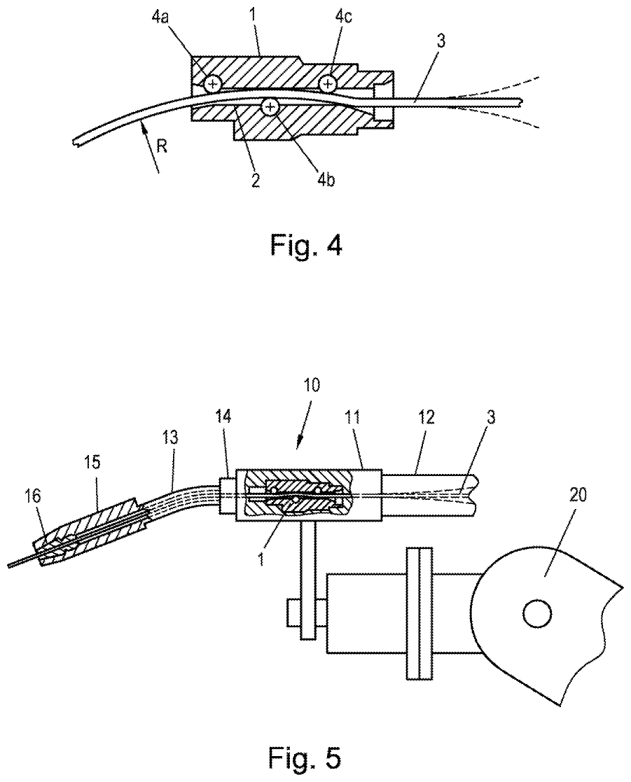

FIG. 4 shows the achieved bend of a welding wire in the wire forming unit.

FIG. 5 shows an exemplary arrangement of the wire forming unit in a welding torch,

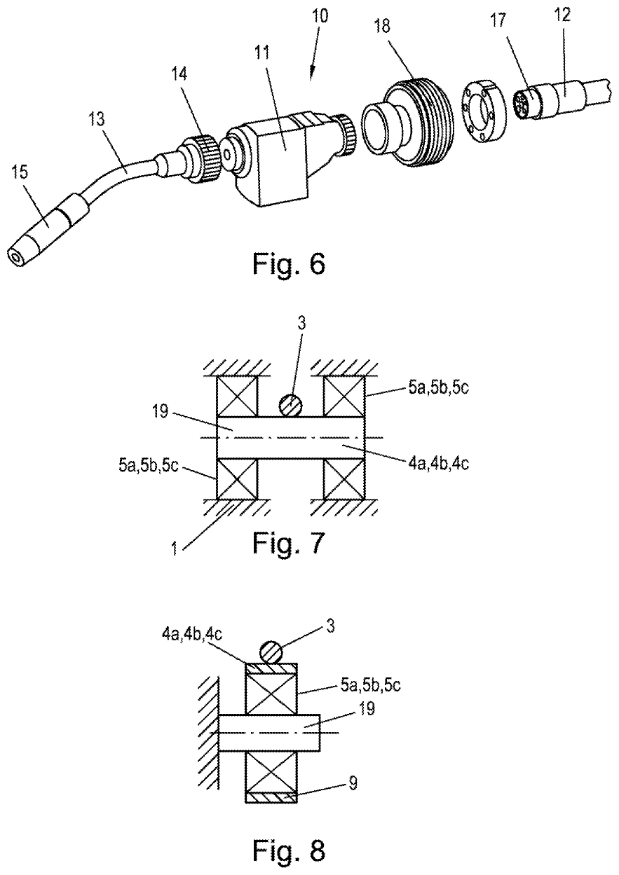

FIG. 6 shows further possible installation locations of the wire forming unit in a welding torch,

FIG. 7 and 8 show possible embodiments of a ball bearing-mounted roller in the wire forming unit.

FIG. 1 shows a section through a wire forming unit 1 according to the invention in a side view (section A-A), and FIG. 2 shows the wire forming unit 1 in a section in a top view (section B-B). A continuous channel 2 for passing a welding wire 3 in the longitudinal direction x (indicated by the movement arrow) is provided in the wire forming unit 1, which longitudinal direction substantially corresponds to the direction of movement of the welding wire 3. The channel 2 can of course also be made significantly larger than shown in FIGS. 1 and 2. For example, the wire forming unit 1 could be designed as a hollow housing, whereas the entire cavity would form the channel 2. For threading the welding wire 3, however, it can be advantageous to guide the welding wire 3 in a narrow channel 2. The channel 2 is in any case preferably of such a size that the welding wire 3 does not touch a channel wall of the channel 2 at any point to avoid any frictional forces.

In the wire forming unit 1, three rollers 4a, 4b, 4c are arranged next to one another in the longitudinal direction x, over which the welding wire 3 is guided. The three rollers 4a, 4b, 4c are rotatably arranged in the wire forming unit 1 by means of ball bearings 5a, 5b, 5c. The welding wire 3 rests on rolling surfaces 6a, 6b, 6c of the rollers 4a, 4b, 4c. For this purpose, the two outer rollers 4a, 4c, when viewed in the longitudinal direction x, and the central roller 4b therebetween are offset in the transverse direction y transversely to the longitudinal direction x such that the welding wire 3 is passed between the rolling surfaces 6a, 6c of the two outer rollers 4a, 4e and the rolling surface 6b of the central roller 4b. The transverse offset V of the central roller 4b in the direction of the two outer rollers 4a, 4c results in a zig-zag-shaped path of the welding wire 3 through the wire forming unit 1 with three deflection points 7a, 7b, 7c, at which the welding wire 3 is formed. The first deflection point 7a results between the first roller 4a and the welding wire 3, the second deflection point 7b between the second roller 4b and the welding wire 3, and the third deflection point 7b between the first roller 4a and the welding wire 3. Due to the transverse offset V, the deflection points 7a, 7c of the two outer rollers 4a, 4c and the deflection point 7b of the central roller 4b are arranged facing one another. At each deflection point 7a, 7b, 7c, the welding wire 3 is consecutively bent each time in a different direction, which results in the zig-zag-shaped path, and is thereby subjected to a plastic deformation that gives the welding wire 3 the desired bend, that is to say, a curvature radius defined within narrow limits. The wire bend of the welding wire 3 upstream of the wire forming unit 1, which is undefined by the pre-curvature, is reduced in a defined manner due to the plastic deformation in the wire forming unit 1 and thus has only little influence on the curvature of the welding wire 3 downstream of the wire forming unit 1.

The transverse offset V is measured from a neutral position (indicated by dashed lines in FIG. 1) of the welding wire 3, in which the welding wire 3 is in contact with the rolling surface 6a, 6b, 6c of the three rollers 4a, 4b, 4c, but not deformed in the transverse direction y—the welding wire 3 would thus run straight through the wire forming unit 1 in the longitudinal direction x without being bent at the deflection points 7a, 7b, 7c. The transverse offset V of the central roller 4b in the direction of the two outer rollers 4a, 4c results in the zig-zag-shaped path of the welding wire 3 through the wire forming unit 1.

The necessary plastic deformation for the desired bend of the welding wire 3 is set via the transverse offset V of the central roller 4b. The greater the transverse offset V, the greater the curvature of the welding wire 3 running over the central roller 4b. For plastic deformation, a certain limit curvature is necessary to exceed the elastic limit. This limit curvature depends primarily on the diameter of the welding wire 3 and/or on the welding wire material and can be assumed to be known. However, it immediately follows that the transverse offset V should be adapted for different welding wire diameters and/or different welding wire materials to reliably achieve the desired bend. This can be done by arranging the central roller 4b to be adjustable in the transverse direction y or by providing 3 different wire forming units 1 for different welding wires. In the latter case, the outer dimensions of the wire forming unit 1 are preferably the same.

To achieve the curvature necessary for the plastic deformation, the axial distance A in the longitudinal direction x between the axes of rotation of the two outer rollers 4a, 4c is maximally 35 mm, preferably maximally 30 mm, very particularly advantageously maximally 20 mm. This maximum axial distance A is important because it was recognized that a larger axial distance would be possible, but this would lead to considerable disadvantages, as explained with reference to FIG. 3. A first roller arrangement having the three rollers 4a, 4b, 4c is indicated in FIG. 3, the two outer rollers 4a, 4c having a first axial distance A1. To set the necessary curvature (curvature radius R) of the welding wire 3, a first transverse offset V1 is required. This results in an angle α1 between the longitudinal direction x and the welding wire 3 on one of the outer rollers 4a, 4c. If the axial distance is now increased, a larger transverse offset V2 is necessary in order to set the same curvature (curvature radius R) of the welding wire 3. This also results in a larger angle α2 between an outer roller 4a, 4c and the longitudinal direction x. Due to the larger axial distance A2 and the larger transverse offset V2, the wire forming unit 1 would of course have a larger size on the one hand. This is particularly disadvantageous when one considers that the wire forming unit 1 should preferably be arranged in the region of the welding torch or even in the welding torch, as explained below. Due to the larger angle α2 between an outer roller 4a, 4c and the longitudinal direction x, a larger deflection on the two outer rollers 4a, 4c would inevitably be required for a given channel 2 to further feed the wire in the longitudinal direction x. This also increases the counter-curvature of the welding wire 3 at the first and third deflection points 7a, 7c (counter-curvature radius R1 in FIG. 3), which in turn may lead to a plastic deformation of the welding wire 3, which may in full or in part eliminate the desired bend of the welding wire 3 by the plastic deformation on the central roller 4b. The desired plastic deformation of the welding wire 3 for impressing the bend thus takes place on the central roller 4b by means of its transverse offset V with respect to the two outer rollers 4a, 4c. No plastic deformation, or at least no excessive plastic deformation, of the welding wire 3 should take place on the two outer rollers 4a, 4c due to the counter-curvature. Therefore, the counter-curvature radius R1 should not be too small in order to prevent further plastic deformation of the welding wire 3, or at least to limit it sufficiently. It has proven to be advantageous if the counter-curvature radius R1 is at least twice the curvature radius R, which would lead to a counter-deformation of at most 50% of the deformation due to the transverse offset V. in this way, the plastic deformation on the middle roller 4b dominates and the bend achieved can be controlled.

The wire forming unit 1 according to the invention thus comprises a deformation area on the central roller 4b to give the welding wire 3 a curvature (bend) by means of plastic deformation in a defined direction due to the transverse offset V. Furthermore, the wire forming unit 1 comprises two counter-deformation regions on the two outer rollers 4a, 4c on which the welding wire 3 is deflected because of the guiding in the channel 2 and undergoes an opposite counter-deformation. This may be elastic or plastic. In the case of plastic deformation, the counter-deformation makes up maximally 50% of the deformation on the central roller 4b.

This can be explained using a simple example. A channel 2 having a channel width b=5 mm (indicated by dashed lines in FIG. 3) is assumed. A welding wire 3 having a welding wire diameter d=1 mm is intended to undergo a plastic deformation (strain) of e=1% in the wire forming unit 1. The strain is known to be the ratio of the radius of the welding wire 3 to the curvature radius R (ε=d/2/R. Thus, a curvature radius R of 50 mm is required. With an axial distance A1=20 mm, a transverse offset V1=1.01 mm would be required to set this curvature radius R, which leads to an angle α1=11.5°. A counter-curvature radius R1=148 mm would result for the given channel 2, which would lead to a counter-deformation of ε1=0.34%. The counter-deformation is thus significantly smaller than the deformation caused by the transverse offset V1, as a result of which the plastic deformation of the welding wire 3 would be maintained to a sufficient extent by the necessary counter-deformation. If the axial distance were increased to A2=30 mm for said welding wire 3 in this example, a transverse offset V2=2.3 mm would be required for a curvature radius R=50 mm and an angle α2=17.4° would result. For the given channel 2, however, there would be a counter-curvature radius R1=37 mm, which would lead to a counter-deformation ε1=1.35%. The counter-deformation would therefore be significantly greater than the deformation due to the transverse offset V2, which would eliminate the desired bend again. This could be counteracted by enlarging the channel 2, which in turn, however, would be disadvantageous for the size of the wire forming unit 1 and for threading the welding wire 3. If the axial distance is reduced in this example, for example to A=10 mm, the necessary transverse offset V would become smaller and the counter-deformation ε1=0.07% would also be substantially smaller than the deformations due to the transverse offset.

The result of the bend in the wire forming unit 1 is shown in FIG. 4. A welding wire 3 that is fed to the wire forming unit 1 in any indefinite bend and orientation (indicated by the dashed lines) is plastically deformed in the wire forming unit 1 such that the welding wire 3 leaves the wire forming unit 1 with a defined bend (curvature radius R). In addition, the orientation of the welding wire 3 relative to the wire forming unit 1 is also determined by the defined deformation in the wire forming unit 1. It should be noted here that the impressed bend of the welding wire 3 is retained even if it is fed further, as long as the welding wire 3 is not subjected to any further plastic deformations. If the welding wire 3 is only elastically deformed during further feeding, this does not change the bend of said welding wire.

The ball bearing mounting of the rollers 4a, 4b, 4c is important for minimizing the frictional forces in the wire forming unit 1 as much as possible. A plain bearing would be conceivable, but would significantly increase the frictional forces. Low frictional forces are important because the feed forces for the welding wire 3 are low or, with the same feed forces, the dynamics of the welding wire feed may be increased. In certain welding processes, the welding wire 3 is not fed continuously to the welding point, but rather in pulses. There are also welding processes in which the welding wire 3 is moved back and forth at a specific frequency. Wire feed changes having frequencies of up to 300 Hz are typical. Low frictional forces in the wire forming unit 1 enable such highly dynamic welding wire feeds.

When using the wire forming unit 1, it is essential according to the invention that the wire forming unit 1 is aligned with the welding torch 10 in a defined and fixed installation position, as explained with reference to FIG. 5. This is to ensure that there can be no uncontrolled deformation, in particular plastic deformation, of the welding wire 3 due to guiding the welding wire 3 in the welding torch 10. The wire forming unit 1 is therefore preferably arranged in a fixed position in the welding torch 10. This means that no uncontrolled deformation can occur downstream of the wire forming unit 1. The welding torch 10 usually comprises a torch base 11 to which a hose pack 12 is connected. The hose pack 12 supplies the welding torch 10 with all the required media, for example protective gas, coolant, welding wire 3, etc., and lines, for example electrical welding current, control lines between the welding torch 10 and the welding power source (not shown), etc. A torch neck 13 is arranged at the other end of the torch base 11 via a contact piece 14, at the axial end of which torch neck a torch head 15 is arranged, in which a contact sleeve 16 (often also called a contact tube or contact tip) is arranged. The hose pack 12 could, however, also be connected directly to the connecting piece 14, whereby the torch base 11 could also be omitted. The contact sleeve 16 is kept at an electrical potential in a known manner such that when the contact sleeve 16 is contacted by the welding wire 3, an electrical welding current may flow through the welding wire 3. The welding wire 3 is fed via the hose pack and is passed through the torch neck 13 into the contact sleeve 16. A wire feed unit may also be provided in the torch base 11 to feed the welding wire 3 through the welding torch 10. For this purpose, the torch base 11 may also be designed as a wire feed unit. However, the wire feed unit may also be arranged at another position. The welding torch 10 may be designed as a handheld welding torch 10 or as a welding torch 10 for a welding robot 20, as indicated in FIG. 5.

The wire forming unit 1 ensures that the welding wire 3 obtains a defined, required bend (curvature radius). The defined and fixed installation position relative to the welding torch 10 in turn ensures that the welding wire 3 is present in a defined orientation (direction of curvature) relative to the welding torch 10. Said bend acts like a pretensioning of the welding wire 3 such that it can be ensured by the defined curvature radius R and the defined orientation the welding wire always contacts the contact sleeve 16 at the substantially same contact point with the substantially same contact force. By setting the transverse offset V in the wire forming unit 1, the contact point may also be influenced within certain limits. The curvature radius R may be predetermined or set by the transverse offset V of the central roller 4b in the wire forming unit 1 as described above. The orientation results from the defined installation position of the wire forming unit 1 in the welding torch 10.

The wire forming unit 1 may be installed at various points in the welding torch 10, as explained with reference to FIG. 6. One possibility is the arrangement in the torch base 11 (FIG. 5), or in a wire feed unit if the torch base 11 is designed as a wire feed unit. The wire forming unit 1 may also be arranged in the connecting piece 14, that is to say, in the connection between the torch base 11 and the torch neck 13. Likewise, the wire forming unit 1 may be arranged in the torch neck 13 or the torch head 15 between the connecting piece 14 and the contact sleeve 16. If the welding torch 10 is equipped with a torch base 11 in the form of a wire feed unit, as shown in FIG. 6, an arrangement of the wire forming unit 1 in the wire feed unit itself is also possible. Arrangement in a robot connecting piece 18 for connecting the welding torch 10 to a welding robot 20 would also be conceivable if the welding torch 10 is used on a welding robot 20. Last but not least, the wire forming unit 1 could also be arranged in a hose pack coupling 17 with which the hose pack 12 is connected to the welding torch 10. In this case, however, it is important that the wire forming unit 1 is in any case arranged upstream of the beginning of the flexible portion of the hose pack 12 to ensure a defined, fixed installation position relative to the welding torch 10. In principle, the wire forming unit 1 may be arranged at any desired point on the welding torch 10, which permits installation based on the available installation space. For this purpose, the smallest possible size of the wire forming unit 1 is of course advantageous, which is also possible due to the small axial distance A.

To be able to build the wire forming unit 1 as compactly as possible, a roller 4a, 4b, 4c, preferably all rollers 4a, 4b, 4c, may also be mounted on two ball bearings 5a, 5b, 5c, as shown in FIG. 7. For this purpose, the roller 4a, 4b, 4c could be designed as a pin 19 that is rotatably arranged in the inner rings of two adjacent bail bearings 5a, 5b, 5c. The roller 4a, 4b, 4c is arranged in the wire forming unit 1 via the outer rings of the ball bearings 5a, 5b, 5c. Bearing forces may thus be halved and smaller ball bearings 5a, 5b, 5c may be used. A roller 4a, 4b, 4c may of course also have a circumferential groove, for example a V-shaped or circular-arc-shaped notch extending over the circumference, to be able to better guide the welding wire 3 on the roller 4a, 4b, 4c. If only one ball bearing 5a, 5b, 5c is used, the outer ring of a ball bearing 5a, 5b, 5c may also function directly as a roller 4a, 4b, 4c (FIG. 8). For this purpose, the bail bearing 5a, 5b, 5c would be fixed in the wire forming unit 1, for example via the inner ring and a pin 19. Likewise, a running sleeve 9 could be arranged on the outer ring of a ball bearing 5a, 5b, 5c, which running sleeve serves as a roller 4a, 4b, 4c (FIG. 8).

1. A method for forming a welding wire using a wire forming unit, whereas the welding wire is led over three ball bearing-mounted rollers arranged one behind the other in the longitudinal direction of the welding torch in the wire forming unit, whereas the central roller, when viewed in the longitudinal direction, is offset in the wire forming unit relative to the two outer rollers, when viewed in the longitudinal direction, by a transverse offset in a transverse direction transverse to the longitudinal direction in order to form a zig-zag-shaped path for the welding wire through the wire forming unit, wherein the welding wire in the wire forming unit is plastically deformed on the central roller and is deformed on the two outer rollers in a direction opposite to the deformation on the central roller, whereas the two outer rollers, when viewed in the longitudinal direction are arranged at an axial distance of maximally 20 mm and the welding wire is deformed on the two outer rollers maximally 50% of the deformation due to the transverse offset on the central roller in order to give the welding wire a defined curvature radius.

2. The method according to claim 1, wherein the transverse offset adjusted depending on the welding wire, preferably depending on the welding wire diameter and/or the welding wire material.

3. (canceled)

4. A method for feeding a welding wire into a, welding torch having a contact sleeve, whereas the welding wire being passed through the welding torch and the contact sleeve, and the contact sleeve being contacted by the welding wire, and a wire forming unit being arranged in the welding torch upstream of the contact sleeve, through which wire forming unit the welding wire is passed and with which the welding wire is thereby formed using a method according to claim 1, such that the welding wire leaves the wire forining unit with defined bend, whereas the wire forming unit being arranged in the welding torch in a defined and fixed installation position relative to the welding torch such that and the welding wire always contacts the contact sleeve through the defined bend at substantially same contact point with the substantially same contact force.

5. (canceled)

6. The method according to claim 4, wherein the wire forming unit is arranged in a torch base of the welding torch.

7.-8. (canceled)

9. The method according to claim 4, the welding wire is fed through the welding torch using a wire feed unit in the torch base.
